(19) United States
(12) Patent Application Publication
(10) Pub. No.: US 2025/0313204 A1
(43) Pub. Date: Oct. 9, 2025

(54) VEHICLE CONTROLLER

(71) Applicant: TOYOTA JIDOSHA KABUSHIKI KAISHA, Toyota-shi (JP)

(72) Inventor: Fumito ITOH, Susono-shi (JP)

(73) Assignee: TOYOTA JIDOSHA KABUSHIKI KAISHA, Toyota-shi (JP)

(21) Appl. No.: 19/053,613

(22) Filed: Feb. 14, 2025

(30) Foreign Application Priority Data
Apr. 5, 2024 (JP) 2024-061541

(51) Int. Cl. B60W 30/16

(52) U.S. Cl. CPC B60W 30/16; B60W 2540/103; B60W 2554/4041; B60W 2554/802; B60W 2710/18; B60W 2720/106

(57) ABSTRACT

A vehicle controller includes: an acquisition unit for obtaining peripheral information of the vehicle, a calculation unit for calculating a basic request deceleration, a support unit for executing a deceleration support control by controlling a requested deceleration when a starting condition is satisfied; and a control unit for controlling a braking device. Further, the starting condition refers to a case where the change amount per unit time of the accelerator opening degree is less than a predetermined change threshold, and the requested driving force is less than a predetermined deceleration threshold, and the support unit updates the requested deceleration to the basic request deceleration if the accelerator pedal is being operated in a direction in which it is returned during an execution of the deceleration support control, and maintains the requested deceleration if the accelerator opening degree does not change during the execution of the deceleration support control.

### CROSS-REFERENCE TO RELATED APPLICATION(S)

The present application claims priority to and incorporates by reference the entire contents of Japanese Patent Application No. 2024-061541 filed in Japan on Apr. 5, 2024.

### BACKGROUND

The present disclosure relates to a vehicle controller.

Japanese Laid-open Patent Publication No. 2001-233085 discloses a vehicle controller for controlling deceleration of a vehicle based on a distance between vehicles and a degree of accelerator opening with a preceding vehicle. In the configuration described in Japanese Laid-open Patent Publication No. 2001-233085, the absolute value of the degree of accelerator opening becomes the execution condition of the deceleration support control, and the deceleration support control is executed so as to generate a predetermined braking force in the braking device when the accelerator pedal is returned to the fully closed position side from the fuel shut-off position.

### SUMMARY

There is a need for providing a vehicle controller capable of preventing the deceleration of an actual vehicle from deviating from a driver's intention to decelerate.

According to an embodiment, a vehicle controller for controlling deceleration of a vehicle in response to an operation of an accelerator pedal by a driver of the vehicle, includes: an acquisition unit for obtaining peripheral information indicating a peripheral state of the vehicle, a calculation unit for calculating a basic request deceleration based on the peripheral information, a support unit for executing a deceleration support control for supporting deceleration of the vehicle by controlling a requested deceleration when a starting condition is satisfied, which is for determining a deceleration intention of the driver, and is based on a change amount per unit time of an accelerator opening degree and a requested driving force; and a control unit for controlling a braking device so as to generate a braking force corresponding to the requested deceleration. Further, the starting condition refers to a case where the change amount per unit time of the accelerator opening degree is less than a predetermined change threshold value, and the requested driving force is less than a predetermined deceleration threshold value, the change threshold value is a negative value, and the support unit updates the requested deceleration to the basic request deceleration so as to change the deceleration of the vehicle if the accelerator pedal is being operated in a direction in which the accelerator pedal is returned during an execution of the deceleration support control, and maintains the requested deceleration so as not to change the deceleration of the vehicle if the accelerator opening degree does not change during the execution of the deceleration support control.

### BRIEF DESCRIPTION OF THE DRAWINGS

FIG. 1 is a diagram schematically illustrating a vehicle in the embodiment;

FIG. 2 is a block diagram for explaining a controller;

FIG. 3 is a flowchart illustrating a braking control;

FIG. 4 is a flowchart illustrating a deceleration support control;

FIG. 5 is a time chart illustrating a state in which the deceleration of the vehicle changes when the deceleration support control is executed; and

FIG. 6 is a time chart illustrating a state in which the deceleration of the vehicle changes when the deceleration support control of the comparative example is executed.

### DETAILED DESCRIPTION

In the related art, in a configuration in which deceleration support control is executed when the accelerator pedal is returned, starting and ending of deceleration support control may be specified by a unique degree of accelerator opening, such as acceleration OFF and accelerator ON (whether the degree of accelerator opening is 0% or other than 0%). In this case, it is conceivable to execute the deceleration support control even during the accelerator pedal operation by the driver. However, if the start and terminate of the deceleration assistance are specified by a unique degree of accelerator opening in the deceleration assistance control during the accelerator pedal operation, the driver's intention of deceleration may deviate from the actual vehicle's deceleration, causing the driver to feel uncomfortable.

Hereinafter, a vehicle controller in the embodiment of the present disclosure will be specifically described. Note that the present disclosure is not limited to the embodiments described below.

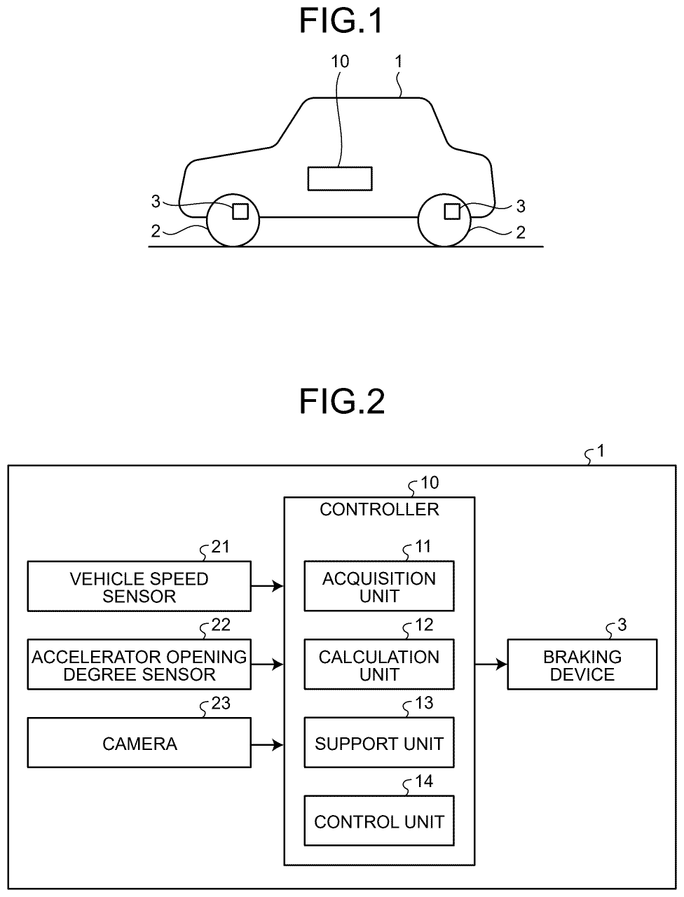

FIG. 1 is a diagram schematically illustrating a vehicle according to an embodiment. The vehicle 1 includes a braking device 3 for applying a braking force to the wheels 2, and a controller 10 for controlling the deceleration of the vehicle 1. The controller 10 is a vehicle controller.

The braking device 3 is a device that can give deceleration to the vehicle 1, to generate a braking force to brake the vehicle 1. For example, the braking device 3 is constituted by a hydraulic brake or a regenerative brake. If the braking device 3 is a hydraulic brake, the braking device 3 is provided for each wheel 2. If the braking device 3 is a regenerative brake, the braking device 3 is realized by an electric motor mounted on the vehicle 1. The vehicle 1 is an electric vehicle equipped with an electric motor as a power source. The braking device 3 is controlled by the controller 10.

The controller 10 is an electronic controller for controlling the braking device 3. The controller 10 includes a CPU, a RAM, a ROM, and a microcomputer with an input/output interface. The controller 10 performs signal-processing in accordance with a program previously stored in the ROM. The controller 10 is inputted signals from various sensors mounted on the vehicle 1. As illustrated in FIG. 2, the vehicle 1 includes a vehicle speed sensor 21 for detecting a vehicle speed, an accelerator opening degree sensor 22 for detecting an accelerator opening degree that is an operation amount of an accelerator pedal, and a camera 23 for photographing a peripheral state of the vehicle 1. The signal from the vehicle speed sensor 21, the signal from the accelerator opening degree sensor 22, and the signal from the camera 23 are input to the controller 10. The controller 10 executes various controls based on signals input from various sensors.

The controller 10 calculates a required driving force based on the vehicle speed and the degree of acceleration. The controller 10 calculates the required power based on the required driving power and the vehicle speed. The controller 10 controls the torque output from the power source based on the required power.

The controller 10 executes the deceleration support control to support deceleration of the vehicle 1 on the basis of peripheral situations of the vehicle 1. The deceleration support control is control for adjusting the deceleration of the vehicle 1 when the accelerator pedal is operated in a direction to be returned in a state in which the brake pedal is not pressed (brake OFF). In order to reduce the load of the driver of the vehicle 1 and improve the sense of security, the controller 10 appropriately adjusts the deceleration of the vehicle 1 in a traveling scene in which the vehicle 1 needs to be decelerated, such as a scene in which the vehicle 1 approaches a preceding vehicle or before the vehicle 1 enters a curve. At that time, the controller 10 controls so that the deceleration of the vehicle 1 changes while the driver is operating the accelerator pedal, and controls so that the deceleration of the vehicle 1 does not change when the driver is not operating the accelerator pedal. Thus, the deceleration of the vehicle 1 can be changed based on the operation status of the driver or the vehicle state, and the feeling of deceleration can be adjusted without giving a sense of discomfort or anxiety to the driver.

As illustrated in FIG. 2, the controller 10 includes an acquisition unit 11, a calculation unit 12, a support unit 13, and a control unit 14.

The acquisition unit 11 acquires peripheral information indicating the peripheral state of the vehicle 1. The peripheral information includes information indicating the distance between the vehicle 1 and the preceding vehicle, information indicating that the vehicle 1 is before entering the curve, information indicating R of the forward curve, and the like. The vehicle 1 includes an acquisition device capable of acquiring information on the peripheral situation of the vehicle 1. The acquiring device includes a camera 23 and a car navigation device. The camera 23 images the surrounding conditions including the preceding vehicle traveling in front of the vehicle 1. The camera 23 outputs the image data captured in front of the vehicle 1 to the controller 10. The car navigation device outputs position information and map information indicating the current position of the vehicle 1 to the controller 10. The acquisition unit 11 acquires peripheral information based on the information input from the acquisition device to the controller 10. The acquisition unit 11 acquires information indicating the distance between the vehicle 1 and the preceding vehicle based on the image data input from the camera 23.

The calculation unit 12 computes the basic requested deceleration based on the peripheral information. The peripheral information may include information indicating that the distance between the vehicle and the preceding vehicle is shortened, or may include information indicating that the distance between the vehicle and the preceding vehicle does not change. The calculation unit 12 calculates the basic required deceleration to a larger value as the distance between vehicles is shorter. Further, the peripheral information may include information indicating the R of the forward curve that the vehicle 1 is scheduled to enter. In this case, the calculation unit 12 computes a large basic required deceleration compared to the case where the vehicle 1 does not enter the curve.

The support unit 13 executes the deceleration support control based on the peripheral situation of the vehicle 1. In the deceleration support control, the deceleration of the vehicle 1 is supported by using the basic required deceleration. The deceleration support control is executed in a traveling scene in which the deceleration of the vehicle 1 is required, such as a case in which the preceding vehicle is traveling near the vehicle 1 or a case in which the vehicle 1 enters the forward curve. If there is no preceding vehicle in the vicinity of the vehicle 1, the support unit 13 does not execute the deceleration support control. As a prerequisite of the deceleration support control, the support unit 13 determines whether a driving scene in which the deceleration of the vehicle 1 is required according to the surrounding conditions. The prerequisites include that the degree of acceleration is greater than 0%. For example, the support unit 13 determines whether the distance between the preceding vehicle is smaller than a predetermined distance threshold value. The distance threshold value is a preset value. The support unit 13 determines that a traveling scene in which the deceleration of the vehicle 1 is required when it is determined that the distance between the preceding vehicle is smaller than the distance threshold value.

The support unit 13 provides the deceleration support at an appropriate timing according to the driver's intention to decelerate. The support unit 13 judges the driver's intention of deceleration and the intention of acceleration when it satisfies the prerequisite of deceleration support control. The support unit 13 determines whether there is an intention to decelerate the driver by using the change amount of the degree of acceleration per unit time and the required driving force. The support unit 13 determines whether there is an acceleration intention of the driver by using the requested driving force. The support unit 13 executes the deceleration support control when it is determined that there is an intention of deceleration of the driver. The support unit 13 ends the deceleration support control when it is determined that there is an acceleration intention of the driver during execution of the deceleration support control. The condition for judging the driver's intention of deceleration becomes a starting condition of deceleration support control. The condition for judging the driver's intention to accelerate becomes an end condition of the deceleration support control. In this description, the starting condition of the deceleration support control may be simply referred to as the starting condition, and the end condition of the deceleration support control may be simply referred to as the end condition.

The starting condition of the deceleration support control is the condition using the change amount per unit time of the degree of acceleration and the required driving force. The starting condition is a case in which the change amount of the degree of acceleration per unit time is smaller than a predetermined change threshold value and a case in which the required driving force is smaller than a predetermined deceleration threshold value. The change threshold is negative. For example, the deceleration threshold is set to 0 [N]. The starting condition is when the change of the degree of acceleration per unit time is a negative value and the required driving force is a negative value. The negative value of the change in degree of acceleration per unit time means that the degree of acceleration is decreasing toward 0%, that is, the driver is returning the accelerator pedal. If the accelerator OFF (0% degree of acceleration) is selected, the starting condition is not met. For example, the change thresholds are set to any value within −30˜−20%/s. A negative value of the required driving force indicates that the vehicle speed is low and the degree of acceleration is small.

The end condition of the deceleration support control is the condition using the required driving force. The end condition is when the required driving force is greater than a predetermined acceleration threshold. The acceleration threshold is a positive value. For example, the acceleration threshold is set to 50 N.

When the deceleration support control is started, the support unit 13 updates the requested deceleration to the basic requested deceleration at an appropriate timing according to the deceleration intention of the driver. The support unit 13 updates the requested deceleration to the basic requested deceleration so as to change the deceleration of the vehicle 1 when the accelerator pedal is being operated in the direction in which the accelerator pedal is returned while the deceleration support control is being executed. When the degree of acceleration does not change during the execution of the deceleration support control, the support unit 13 maintains the requested deceleration so as not to change the deceleration of the vehicle 1. The support unit 13 maintains the requested deceleration so as not to change the deceleration of the vehicle 1 when the degree of acceleration does not change even when the distance between the vehicle and the preceding vehicle becomes short while executing the deceleration support control. When the degree of acceleration starts to decrease further from the state in which the requested deceleration is maintained during the execution of the deceleration support control, the support unit 13 restarts to update the requested deceleration to the basic requested deceleration.

The control unit 14 controls the braking device 3 so as to generate the braking force corresponding to the requested deceleration. The control unit 14 controls the braking force generated by the braking device 3 so that the requested deceleration set by the support unit 13. The control unit 14 outputs a command signal to the braking device 3.

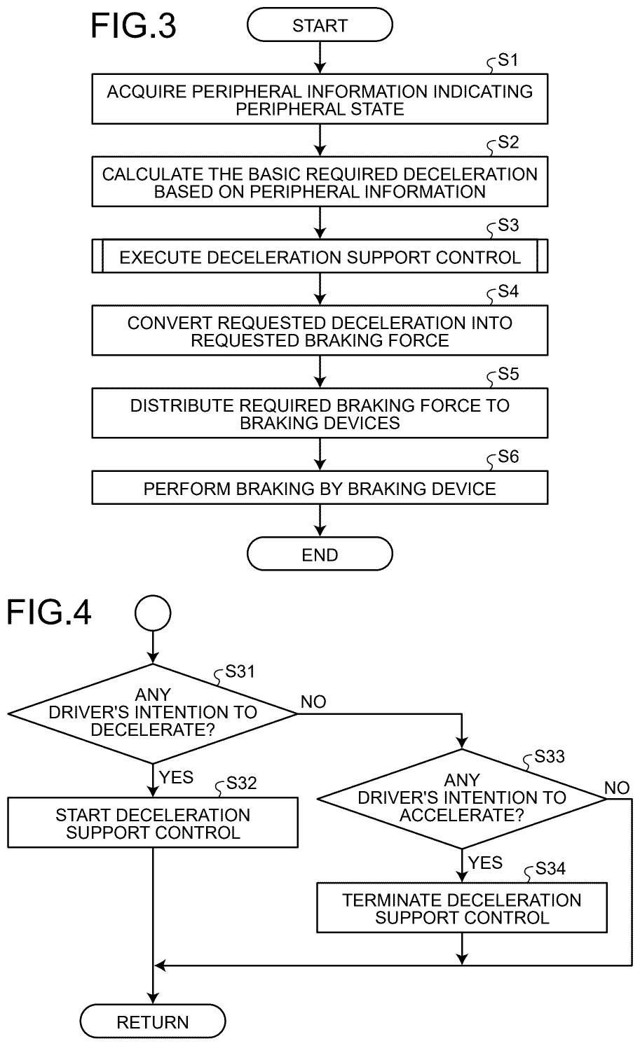

FIG. 3 is a flowchart illustrating a braking control. The control illustrated in FIG. 3 is implemented repeatedly by the controller 10.

The controller 10 acquires peripheral information indicating the peripheral state of the vehicle 1 (step S1). In step S1, peripheral information from the acquiring device such as the camera 23 are acquired. Surrounding information includes information indicating the distance between the vehicle and the preceding vehicle and the R of the forward curve, etc.

The controller 10 calculates the basic required deceleration based on the peripheral information (step S2). In step S2, the basic required deceleration is calculated according to the distance between the vehicle and the preceding vehicle.

The controller 10 executes the deceleration support control (step S3). In step S3, the deceleration support control is executed when the prerequisite of the deceleration support control is satisfied. A subroutine illustrating the process of the stepped S3 is illustrated in FIG. 4.

The controller 10 converts the requested deceleration into the requested braking force (step S4). In step S4, the required braking force is calculated based on the requested deceleration set in step S3. The required braking force is a braking force required for the entire vehicle 1.

The controller 10 distributes the required braking force to the braking devices 3 (step S5). When the braking device 3 is a hydraulic brake, the required braking force is distributed to the braking device 3 provided in each wheel 2. When the braking device 3 includes a regenerative brake and a hydraulic brake, the required braking force is distributed to the electric motor and each hydraulic brake.

The controller 10 performs braking by the braking device 3 (step S6). In step S6, a braking force is generated in the braking devices 3 so as to satisfy the distributed braking force according to the required braking force. Performing the process of step S6, this control routine ends.

FIG. 4 is a flowchart illustrating a deceleration support control. The control illustrated in FIG. 4 is a control executed when the prerequisite for deceleration support control is satisfied, and is a process executed in step S3 illustrated in FIG. 3.

The controller 10 determines whether there is a driver's intention to decelerate (step S31). In step S31, as a condition for judging the intention of deceleration of the driver, it is judged whether the starting condition based on the change of the degree of accelerator opening per unit time and the required driving force is satisfied. The starting condition is a case in which the change amount of the degree of acceleration per unit time is smaller than a predetermined change threshold value and a case in which the required driving force is smaller than a predetermined deceleration threshold value. The change threshold is negative. The deceleration threshold value is zero.

If it is determined that there is a driver's intention to decelerate (step S31: Yes), the controller 10 starts deceleration support control (step S32). In step S32, the support unit 13 updates the requested deceleration to the basic requested deceleration so as to change the deceleration of the vehicle 1. When the support unit 13 is operating in a direction in which the accelerator pedal is returned while the deceleration support control is being executed, the support unit updates the requested deceleration to the basic requested deceleration so as to change the deceleration of the vehicle 1. When the process of step S32 is performed, the subroutine returns to step S31.

If it is determined that there is no driver's intention to decelerate (step S31: No), the controller 10 determines whether there is a driver's intention to accelerate (step S33). In step S33, it is determined whether the end condition of the deceleration support control is satisfied. The end condition is a case where the required driving force is equal to or greater than a predetermined acceleration threshold. The acceleration threshold is a positive value. The support unit 13 determines whether the required driving force is equal to or greater than the acceleration threshold. For example, the acceleration threshold is set to 50 N.

If it is determined that there is an acceleration intent of the driver (step S33: Yes), the controller 10 terminates the deceleration support control (step S34). The support unit 13 terminates the deceleration support control in step S34. When the process of step S34 is performed, the subroutine returns to step S31.

If it is determined that there is no driver's intention of acceleration (step S33: No), the controller 10 determines that the driver's intention is to maintain the current status. For example, when the degree of acceleration does not change during the execution of the deceleration support control, the support unit 13 maintains the requested deceleration so as not to change the deceleration of the vehicle 1. If a negative decision is made at step S33, the subroutine returns to the step S31. If an affirmative decision is made at step S31 after this return, the degree of acceleration begins to decrease further from maintaining the requested deceleration during deceleration support control. In this case, the support unit 13 restarts updating of the requested deceleration to the basic requested deceleration.

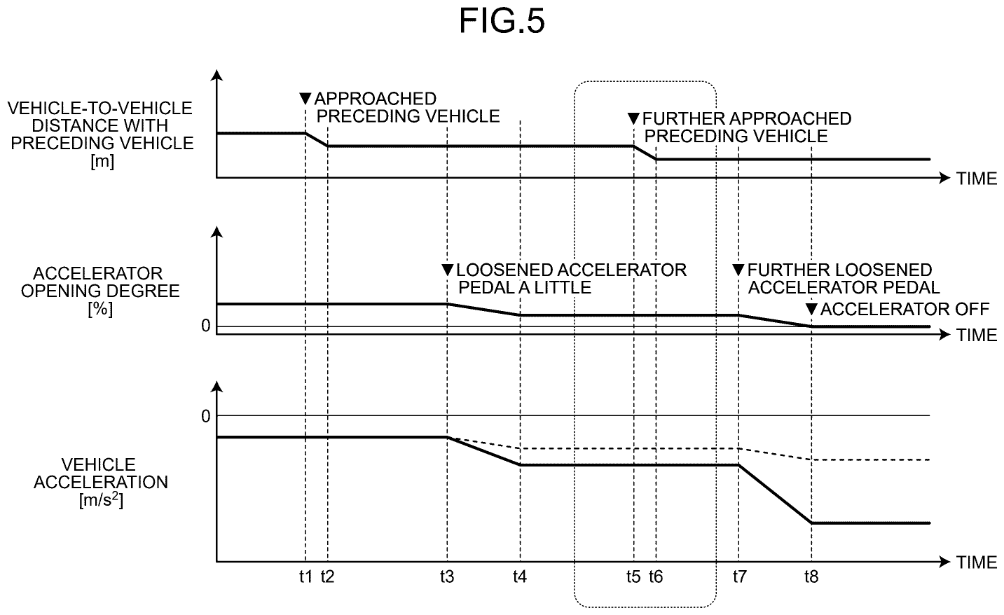

FIG. 5 is a time chart diagram illustrating a state in which the deceleration of the vehicle changes when the deceleration support control is executed. As illustrated in FIG. 5, the distance between the vehicle and the preceding vehicle is shortened (time t1˜t2) in a state where the vehicle acceleration is negative and the degree of acceleration is maintained. The vehicle acceleration indicated by the negative value represents the deceleration of the vehicle 1. The controller 10 does not start the deceleration support control because the starting condition is not satisfied in the vehicle state and the peripheral state of the time t1˜t2. The distance between the vehicle and the preceding vehicle does not change (after the time t2). The driver slightly loosens the accelerator pedal (time t3). It is determined that the starting condition is satisfied in the time t3, and the controller 10 starts the deceleration support control. After starting the deceleration support control, the absolute value of the deceleration of the car 1 is changed to a large value as the degree of acceleration decreases (time t3˜t4). If the degree of acceleration is maintained while deceleration assistance control is executed, the braking force is maintained so that the deceleration does not change (time t4). Then, after starting the deceleration support control (after the time t3), when the driver maintains the accelerator pedal (after the time t4), even if the vehicle-to-vehicle distance with the preceding vehicle becomes short (time t5˜t6), it is controlled so as not to change the vehicle acceleration. Thereafter, when the driver performs an operation to further loosen the accelerator pedal, the braking force is controlled so that the absolute value of the deceleration of the vehicle 1 becomes a larger value (time t7˜t8). Acceleration OFF is performed in the time t8.

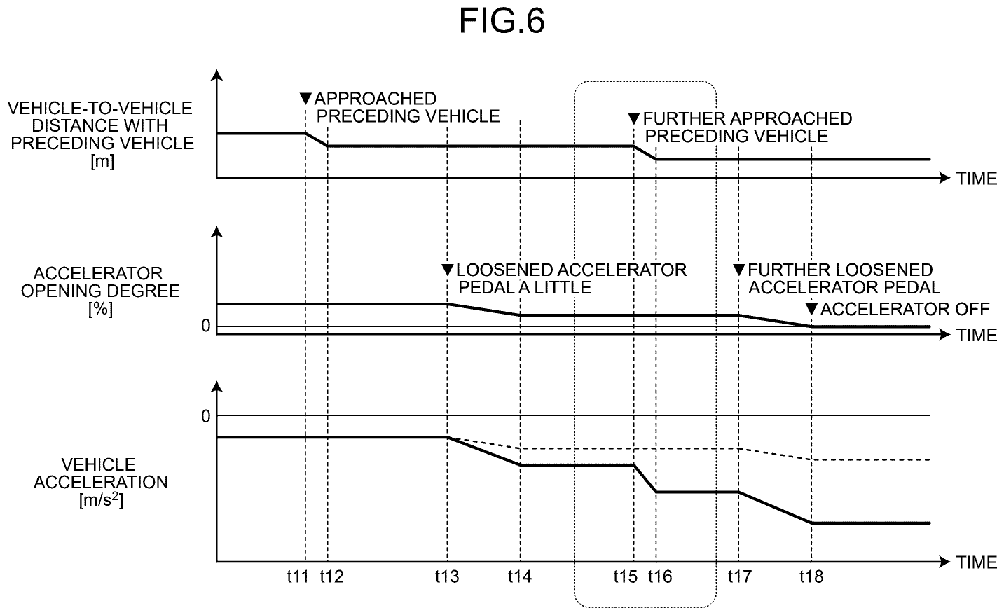

FIG. 6 is a time chart diagram illustrating a state in which the deceleration of the vehicle changes when the deceleration support control of the comparative example is executed. The controller of the comparative example, unlike the controller 10, starts deceleration support control on the basis of the absolute value of the degree of acceleration. As illustrated in FIG. 6, although the vehicle-to-vehicle distance with the preceding vehicle is shortened in the vehicle status and the surrounding conditions at the time t11˜t12, the deceleration support control of the comparative example is not started because the absolute value of the degree of accelerator opening is larger than the starting threshold. When the driver slightly loosens the accelerator pedal in the time t13, the deceleration support control starts because the absolute value of the degree of accelerator opening becomes smaller than the starting threshold. In this comparative example, when the inter-vehicle distance to the preceding vehicle is further shortened while the deceleration support control is being executed (after the time t13), the deceleration changes so that the absolute value of the deceleration of the vehicle is further increased (time t15˜t16). When the driver maintains the accelerator pedal, the vehicle acceleration changes when the distance between the vehicle and the preceding vehicle is shortened. In this case, the vehicle behavior is not suitable for the driver's intention, and there is a possibility of giving a sense of discomfort to the driver.

As described above, according to the embodiment, by utilizing the driver's operation intention and the driver's driving force request to the starting condition and the end condition of the deceleration support control, it is possible to provide the deceleration support according to the driver's operation situation and the vehicle state. Thus, since the deceleration support can be applied at an appropriate timing according to the driver's intention to decelerate, the driver can drive without having a sense of discomfort or the like.

Incidentally, the braking device 3 may be any of the hydraulic brake and the regenerative brake. The braking device 3 may include both a hydraulic brake and a regenerative brake.

The acquisition device capable of acquiring information on the peripheral situation of the vehicle 1 is not limited to the camera 23 and the car navigation device. The acquiring device may include a millimeter wave radar. The vehicle 1 may acquire information indicating the vehicle-to-vehicle distance with a preceding vehicle by a millimeter wave radar instead of the camera 23. The map information is not limited to the car navigation device, and may be acquired by wireless communication with an external device.

In the present disclosure, it is possible to prevent the deceleration of the actual vehicle from deviating from the driver's intention of deceleration.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle controller for controlling deceleration of a vehicle in response to an operation of an accelerator pedal by a driver of the vehicle, comprising:
an acquisition unit for obtaining peripheral information indicating a peripheral state of the vehicle,
a calculation unit for calculating a basic request deceleration based on the peripheral information,
a support unit for executing a deceleration support control for supporting deceleration of the vehicle by controlling a requested deceleration when a starting condition is satisfied, which is for determining a deceleration intention of the driver, and is based on a change amount per unit time of an accelerator opening degree and a requested driving force; and
a control unit for controlling a braking device so as to generate a braking force corresponding to the requested deceleration, wherein
the starting condition refers to a case where the change amount per unit time of the accelerator opening degree is less than a predetermined change threshold value, and the requested driving force is less than a predetermined deceleration threshold value,
the change threshold value is a negative value, and
the support unit is configured to
update the requested deceleration to the basic request deceleration so as to change the deceleration of the vehicle if the accelerator pedal is being operated in a direction in which the accelerator pedal is returned during an execution of the deceleration support control, and
maintain the requested deceleration so as not to change the deceleration of the vehicle if the accelerator opening degree does not change during the execution of the deceleration support control.

2. The vehicle controller according to claim 1, wherein
the peripheral information includes a vehicle-to-vehicle distance information indicating a vehicle-to-vehicle distance with a preceding vehicle traveling in front of the vehicle,
the calculation unit calculates the basic request deceleration to a larger value as the distance between the vehicles is shorter, and
the support unit maintains the requested deceleration so as not to change the deceleration of the vehicle, when the accelerator opening degree does not change even if the distance between the vehicles becomes short while executing the deceleration support control.

3. The vehicle controller according to claim 2, wherein
the support unit restarts updating the requested deceleration to the basic request deceleration when the accelerator opening degree starts to decrease further from a state where the requested deceleration is maintained during execution of the deceleration support control.

4. The vehicle controller according to claim 3, wherein
an end condition, which is a condition for determining an acceleration intention of the driver and for terminating the deceleration support control, is satisfied when the requested driving force is equal to or greater than a predetermined acceleration threshold,
the acceleration threshold is a positive value, and
the support unit ends the deceleration support control when the end condition is satisfied while the deceleration support control is executed.

5. The vehicle controller according to claim 1, wherein
the deceleration threshold value is set to zero.
